(19) United States
(12) Patent Application Publication
(10) Pub. No.: US 2010/0018800 A1
(43) Pub. Date: Jan. 28, 2010

(54) System and method for providing a warning to ladder users of potentially hazardous steps

(76) Inventors: Robert Mark Ventura, Beallsville, PA (US); Steven Willis Onisko, Roscoe, PA (US); Glenn Roy Toothman, III, Waynesburg, PA (US)

Correspondence Address: Robert M. Ventura Sr., 2 Scenery Drive, Beallsville, PA, 15313, US

(21) Appl. No.: 12/220,722

(22) Filed: Jul. 28, 2008

(51) Int. Cl. E06C 7/00; G08B 21/00

(52) U.S. Cl. 182/18; 340/686.1

(57) ABSTRACT

Systems and methods of using the system for providing warning to ladder users of hazardous locations along its span are disclosed. The system comprises a contact strip or contact device located on a specific rung, step or tread on or in close proximity to the hazardous location along the span of the ladder erected for use that when engaged by the weight of a person stepping on said rung, step or tread, the contact strip or device is engaged, activating an electronic warning signal. This signal can occur in a form or combination of forms such as, but not limited to, an auditory alarm, a vibration or a light. This contact strip or device and its accompanying warning signal are powered by a form of electric current provided from any regularly available forms of power such as but not limited to, removable batteries, re-chargeable batteries or power-packs that may be directly plugged into any permanent source of power. This system may comprise a light beam transmitter; said beam can be of visible or invisible light that is generated in a concentrated-beam form across the width of the ladder where it is reflected by a reflecting device on the opposite side of the width of the ladder. Said beam spans a left-to right path across the width of the ladder. Once the user of the ladder moves into the beam as it is placed at or in close proximity to the hazardous location and said user breaks the plane of said light beam this action further activates an electronic warning signal. This signal can occur in a form or combination of forms such as but not limited to, an auditory alarm, a vibration or a light. This beam and its accompanying warning signal are powered by a form of electric current provided from any regularly available forms of power such as but not limited to, removable batteries, re-chargeable batteries or power-packs that may be directly plugged into any permanent source of power. This system may be constructed in a manner that it is installed permanently within the structure of the ladder at set locations consistently considered to be potentially hazardous locations. This system may be constructed as a self-contained unit that is portable, removable and installable at any location along the run of a ladder that its user may deem appropriate. This portable/removable unit is constructed in a housing or container that would facilitate the easy attachment to the ladder structure and made in such a manner to allow for adjustable width to facilitate a variety of installation applications across a spectrum of ladder sizes and designs.

### BACKGROUND

I. Field of the Invention

The present invention relates generally to ladder safety, and more particularly to a system and method for warning users as to the location of potentially hazardous steps along the ladder's span when it is erected and in use.

II. Description

In common use, ladders are erected and placed in an upright manner, positioned at an angle against a structure allowing for its user to have access to locations high above a base location. Generally, ladders erected and placed in use have specific rungs, steps or tread locations along its path that consistently pose a hazard for its user. Specifically, these hazards are due to the location of said rung, step or tread along the path of rungs such as, but not limited to, the rung nearest the base location as well as the highest rung deemed safe for a user to step on. Also, to facilitate access to varying heights, it is common practice for some ladders to allow for two or more sections or extensions to be integrated within one another allowing for the ability to extend the overall useable reach of the ladder to higher locations. The place along the path of rungs, steps or treads where two sections of these extended ladders join is also consistently a hazardous location. Often in the course of ladder use, a person does not have an easy ability to see these hazardous locations as the user moves up or down its span of operation. Accordingly, there is a need for a system and method allowing for users to be warned as to the location of potentially hazardous rungs, steps or treads.

### SUMMARY OF THE INVENTION

The present invention is directed to a system and method for providing a warning to ladder users concerning locations of potentially hazardous rungs, steps or treads along its span when it is erected and in use. In one embodiment, the invention comprises a contact strip or device located on a specific rung, step or tread on or in close proximity to the hazardous location that when engaged by the weight of a person stepping on said rung, step or tread, the contact strip or device is engaged, activating an electronic warning signal. This signal can occur in a form or combination of forms such as, but not limited to, an auditory alarm, a vibration or a light. This contact strip or device and its accompanying warning signal are powered by a form of electric current provided from any regularly available forms of power such as but not limited to, removable batteries, re-chargeable batteries or power-packs that may be directly plugged into any permanent source of power.

In yet another embodiment, the invention comprises a light beam transmitter, transmitting a beam of light in a concentrated-beam form across the width of the ladder where it is reflected by a reflector on the opposite side of the width of the ladder. Said beam spans a left-to right path across the width of the ladder. Once the user of the ladder moves into the beam while moving up or down the span of the ladder and moves into the area where the transmitter is placed, as it is placed at or in close proximity to a hazardous location along the span of the ladder and said user breaks the plane of said light beam this action further activates an electronic warning signal. This signal can occur in a form or combination of forms such as but not limited to, an auditory alarm, a vibration or a light. This beam and its accompanying warning signal are powered by a form of electric current provided from any regularly available forms of power such as but not limited to, removable batteries, re-chargeable batteries or power-packs that may be directly plugged into any permanent source of power.

In yet another embodiment, this system and method for warning ladder users of potentially hazardous locations can be constructed in a manner that it is installed permanently within the structure of the ladder at set locations consistently considered to be potentially hazardous locations.

In yet another embodiment, this system and method for warning ladder users of potentially hazardous locations can be constructed as a self-contained unit that is portable, removable and installable at any location along the run of a ladder that its user may deem appropriate. This portable/removable unit is constructed of a break-resistant material in a housing or container that would facilitate the easy attachment to the ladder structure by means and methods such as but not limited to snap grippers or springs and made in such a manner to allow for adjustable width to facilitate a variety of installation applications across a spectrum of ladder sizes and designs.

### BRIEF DESCRIPTION OF THE DRAWINGS

The features, objects and advantages of the present invention will become more apparent from the detailed description set forth below when taken in conjunction with the drawings, in which like reference characters identify corresponding elements throughout, and wherein:

FIG. 1 is a block diagram of a system for providing a warning to ladder users concerning locations of potentially hazardous rungs, steps or treads along its span when erected for use in accordance with a first preferred embodiment of the invention.

FIG. 2 is a block diagram of a system for providing a warning to ladder users concerning locations of potentially hazardous rungs, step or treads along its span when erected for use in accordance with a second preferred embodiment of the invention.

FIG. 3 is a block diagram of a system for providing a warning to ladder users concerning locations of potentially hazardous rungs, step or treads along its span when erected for use in accordance with a third preferred embodiment of the invention.

FIG. 4 is a block diagram of a system for providing a warning to ladder users concerning locations of potentially hazardous rungs, steps or treads along its span when erected for use in accordance with a fourth preferred embodiment of the invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, several other elements found in a typical warning system. Those of ordinary skill in the art will recognize that other elements are desirable and/or required in order to implement the present invention. However, because such elements are well known in the art, and because they do not facilitate a better understanding of the present invention, a discussion of such elements is not provided herein.

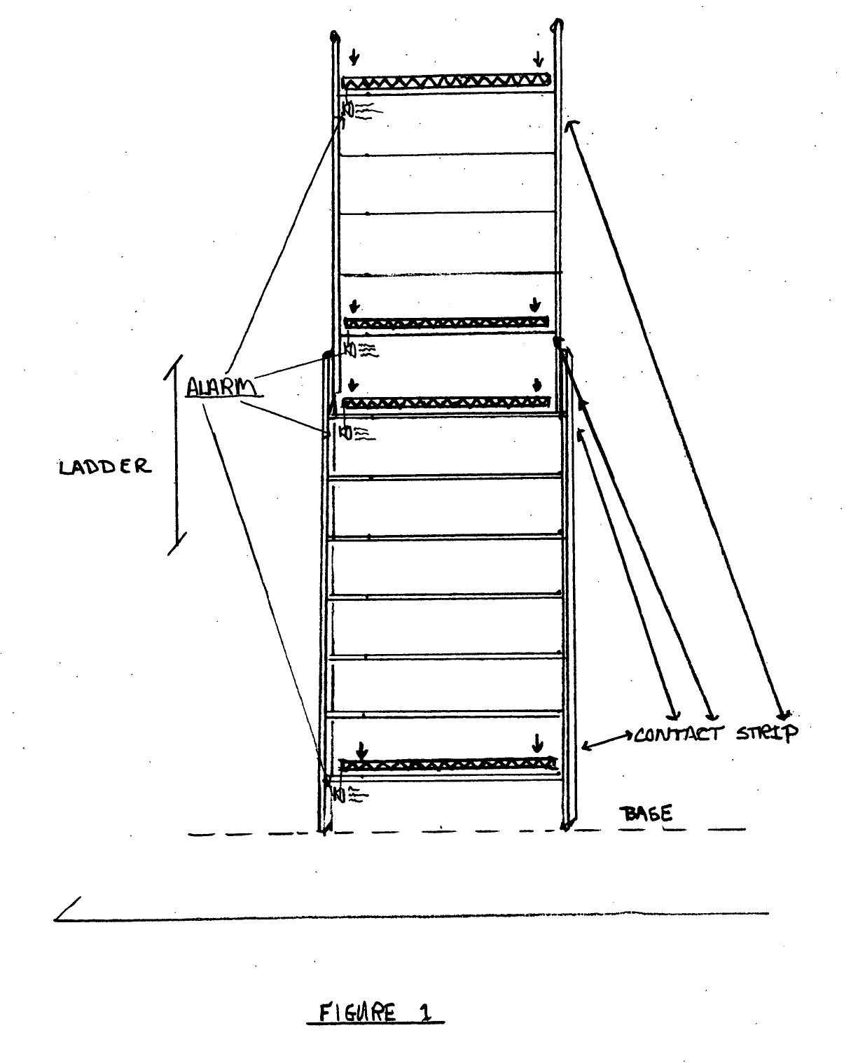

Referring to FIG. 1, there is shown a block diagram of a contact strip. This contact strip is made up of two separated components that are integrated into the rung, step or tread of a ladder and placed at specific locations known to be potentially hazardous along the vertical span of the ladder. The weight of the user, once stepping on this specific rung, step or tread facilitates the separated components of the contact strip to touch thereby activating an electronic warning signal. This warning signal can occur in a form or combination of forms such as, but not limited to, an auditory alarm, a vibration or a light. This warning signal, in its form or combination of forms exists in close proximity to the hazardous location and comprises a small speaker, a vibration unit and/or a light depending upon the selected method of electronic warning signal. Also in close proximity to the rungs, steps or treads near or at the hazardous locations exists a power source to facilitate the activation of the electronic warning device/s.

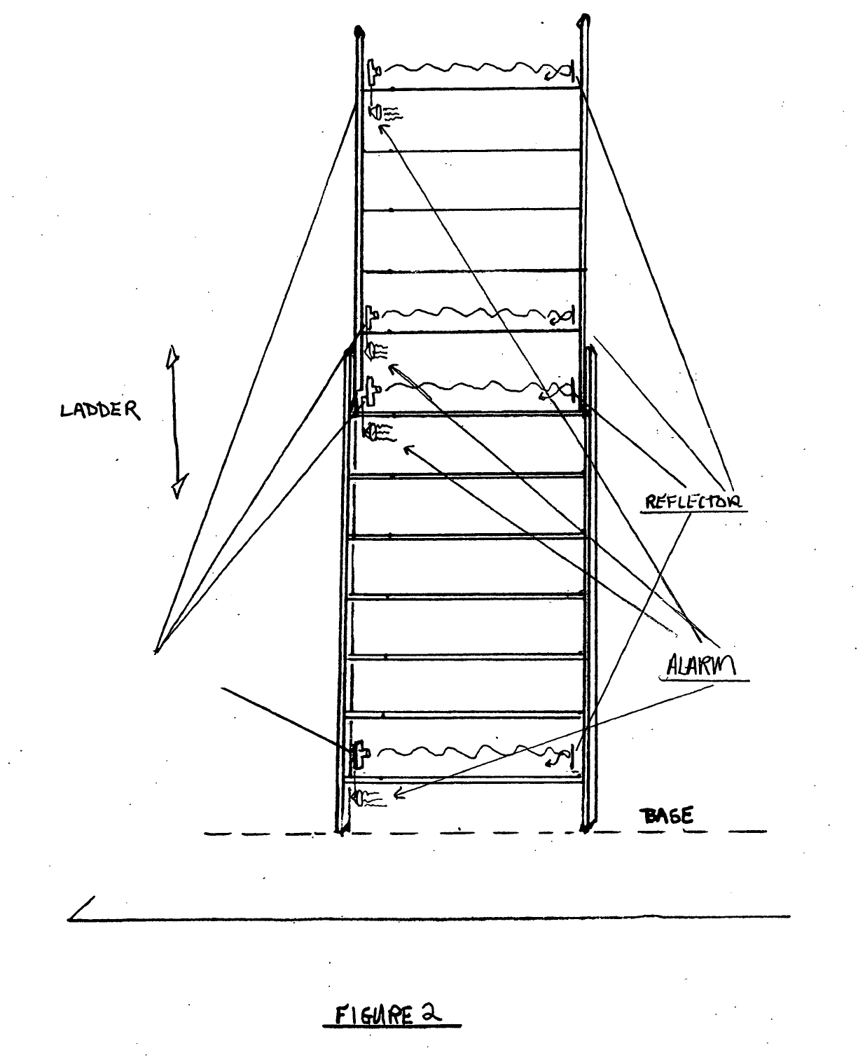

Referring now to FIG. 2, there is shown a block diagram of a warning system incorporating the generation of a light beam via a beam transmitter across the width of the ladder that is reflected left to right across or near a rung, step or tread at a location known to be potentially hazardous. This method consists of a light generation unit that projects its beam across the width of the ladder where this beam strikes a reflecting component maintaining a closed circuit of electricity until such time that the ladder user, by traveling into the beam of light under normal use of the ladder, breaks the circuit and activates an electronic warning signal. This warning signal can occur in a form or combination of forms such as, but not limited to, an auditory alarm, a vibration or a light. This warning signal, in its form or combination of forms exists in close proximity to the hazardous location and comprises a small speaker, a vibration unit and/or a light depending upon the selected method of electronic warning signal. Also in close proximity to the rungs, steps or treads near or at the hazardous locations exist a power source to facilitate the activation of the electronic warning device/s.

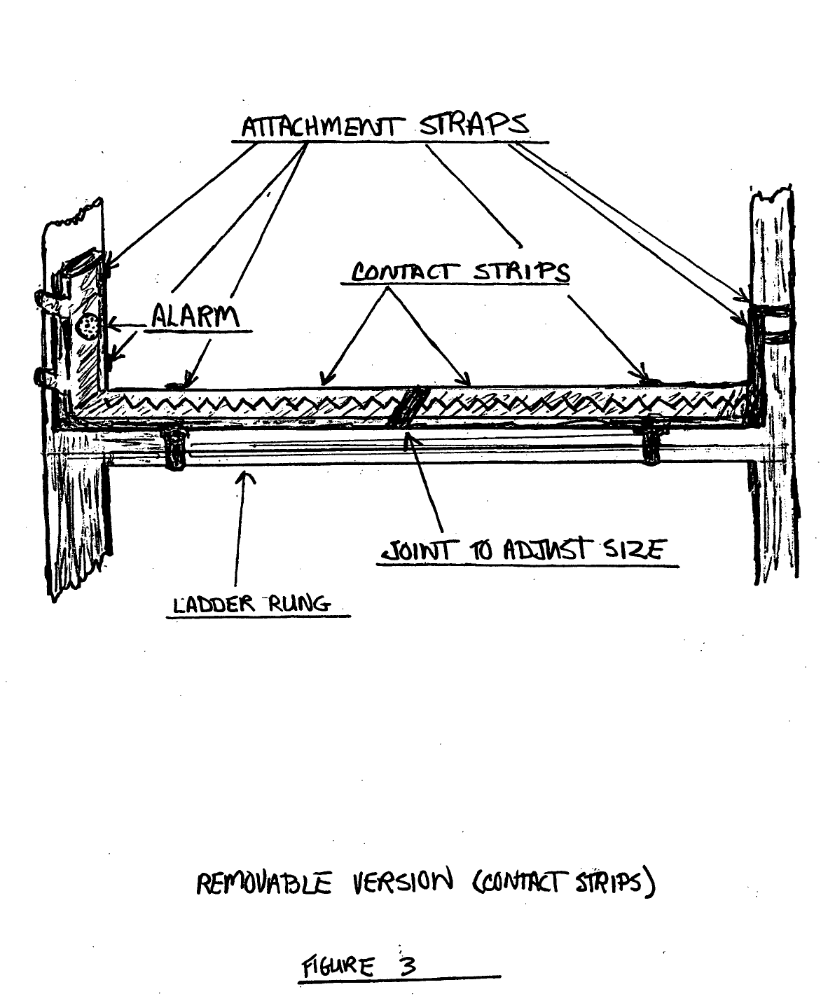

Referring now to FIG. 3, there is shown a block diagram of a portable, self-contained warning system that may be placed at any location along the vertical span of a ladder and adjusted to fit any number of ladders. This portable/removable unit is constructed of an unbreakable material in a housing or container that would facilitate the easy attachment to the ladder structure by means and methods such as but not limited to snap grippers or springs and made in such a manner to allow for adjustable width to facilitate a variety of installation applications across a spectrum of ladder sizes and designs. This portable/removable system consists of a contact strip encapsulated into a unit that contains two separated components that are integrated in such a manner that this unit can be located on the rung, step or tread of a ladder and placed at specific locations determined by the user to be potentially hazardous along the vertical span of the ladder. The weight of the user, once stepping on this specific unit located on a rung, step or tread facilitates the separated components of the contact strip within the unit to touch, thereby activating an electronic warning signal. This warning signal can occur in a form or combination of forms such as, but not limited to, an auditory alarm, a vibration or a light. This warning signal, in its form or combination of forms, exists within the portable/removable unit and comprises a small speaker, a vibration unit and/or a light depending upon the selected method of electronic warning signal. Also within this unit exists a power source to facilitate the activation of the electronic warning device/s. This contact strip contained within this unit and its accompanying warning signal are powered by a form of electric current provided from any regularly available forms of power such as but not limited to, removable batteries, re-chargeable batteries or power-packs that may be directly plugged into any permanent source of power.

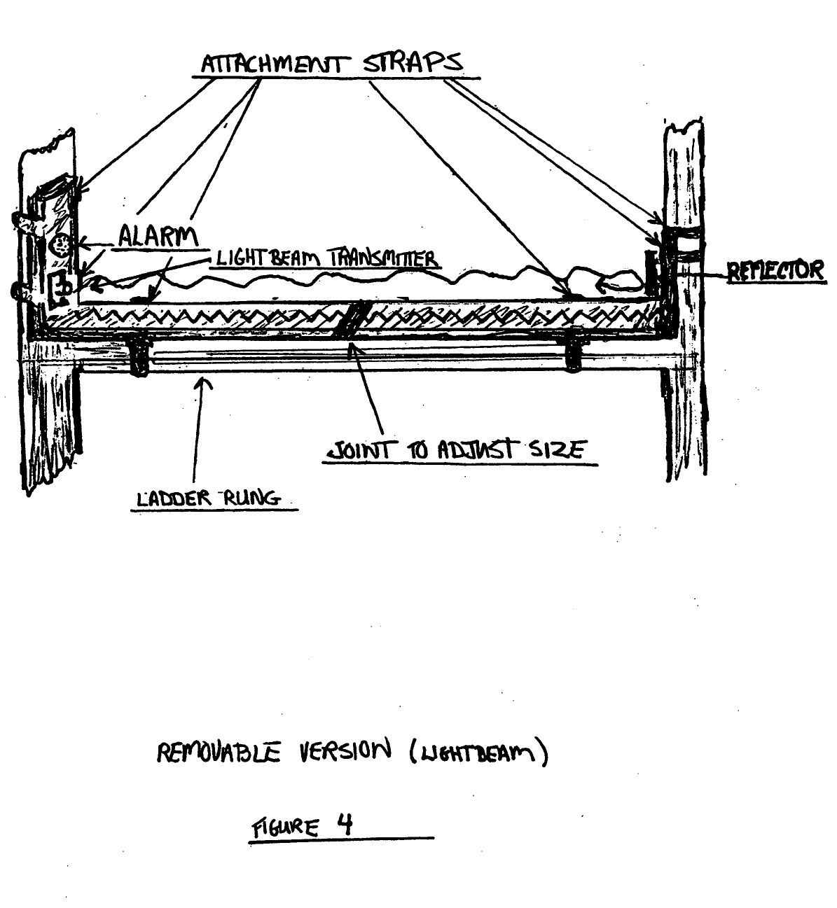

Referring now to FIG. 4, there is shown a block diagram of a portable, self-contained warning system that may be placed at any location along the vertical span of a ladder and adjusted to fit any number of ladders. This portable/removable unit is constructed of an unbreakable material in a housing or container that would facilitate the easy attachment to the ladder structure by means and methods such as but not limited to snap grippers or springs and made in such a manner to allow for adjustable width to facilitate a variety of installation applications across a number of ladder sizes and designs. This portable/removable system consists of a warning system incorporating the generation of a light beam across the width of the ladder that is reflected left to right across or near a rung, step or tread at a location determined by the user to be potentially hazardous. This unit would incorporate a light beam transmitter that projects its beam across the width of the unit and thereby across the width of the ladder where this beam strikes a reflector on the opposite side of the unit and said beam when on maintains a closed circuit of electricity until such time that the ladder user, by traveling into the beam of light under normal use of the ladder, breaks the circuit and activates an electronic warning signal. This warning signal is incorporated into the portable/removable unit and can occur in a form or combination of forms such as, but not limited to, an auditory alarm, a vibration or a light. This warning signal, in its form or combination of forms exists within the portable/removable unit and comprises a small speaker, a vibration unit and/or a light, or any combination of the same, depending upon the selected method of electronic warning signal. Also contained within this unit exists a power source to facilitate the activation of the electronic warning device/s. This light beam transmitter contained within this unit and its accompanying warning signal are powered by a form of electric current provided from any regularly available forms of power such as but not limited to, removable batteries, re-chargeable batteries or power-packs that may be directly plugged into any permanent source of power.

The foregoing description of the preferred embodiments is provided to enable any person skilled in the art to make or use the present invention. Various modifications to the embodiments described above however will be readily apparent to those skilled in the art, and the generic principles defined herein may be applied to other embodiments without the use of inventive faculty. Thus, the present invention is not intended to be limited to the specific systems and methods shown herein but is to be accorded the widest scope consistent with the claims set forth below.

That which is claimed:

1. A system and method for providing a warning to ladder users as to hazardous locations such as where two ladder sections join or the bottom rung, step or tread of a ladder or the ladder's top rung, step or tread all these being at some point along the rungs, steps or treads of the span of a ladder when it is erected and in use and this system is comprising:
(A) A contact strip or contact device located at or in a specific rung, step or tread of the ladder and located in close proximity to the hazardous location that when engaged by the weight of a person stepping on said strip or device on or within the rung, step or tread of the ladder the contact strip or device is engaged, activating an electronic warning signal detectable to the ladder user.
(B) A light beam transmitter of either visible for invisible light that generates a concentrated-beam form of light across the width of the ladder to a reflector unit opposite the location of the beam transmitter and this is located in close proximity to the hazardous location on or near a rung, step or tread of the ladder that when said beam is interrupted by the presence of the foot of a person using the ladder this interruption causes the activation of an electronic warning signal detectable to the user of the ladder.

2. The system of claim 1 comprises a warning signal in a form or combination of forms such as an auditory alarm, a vibration or a light.

3. The system of claim one is powered by a form of electric current provided from any regularly available forms of power such as batteries or electric current available from any plug-in receptacle of any kind.

4. The system of claim 1 may be permanently affixed to the ladder at specific locations.

5. The system of claim 1 may be made as a self-contained unit that is portable and attachable at any potentially hazardous location along the span of a ladder that its user may deem appropriate.
